(19) United States
(12) Patent Application Publication
(10) Pub. No.: US 2021/0197860 A1
(43) Pub. Date: Jul. 1, 2021

(54) VEHICLE AND METHOD OF CONTROLLING THE SAME

(71) Applicants: Hyundai Motor Company, Seoul (KR); Kia Motors Corporation, Seoul (KR); Hyundai Autron Co., Ltd., Seoul (KR)

(72) Inventors: Cheolhyeon Kwon, Suwon (KR); Ho-Jun Kim, Seoul (KR)

(21) Appl. No.: 17/108,785

(22) Filed: Dec. 1, 2020

(30) Foreign Application Priority Data
Dec. 30, 2019 (KR) 10-2019-0177851

(51) Int. Cl. B60W 60/00; B60W 30/16; B60W 30/09; B60W 30/095; B60W 10/18; B60W 10/20; G01S 19/42; B60W 40/04

(52) U.S. Cl. CPC B60W 60/0015; B60W 2554/804; B60W 30/09; B60W 30/0953; B60W 30/0956; B60W 10/18; B60W 10/20; G01S 19/42; B60W 40/04; B60W 2556/65; B60W 2420/52; B60W 2555/20; B60W 2520/10; B60W 2554/4042; B60W 30/16

(57) ABSTRACT

A vehicle providing safe autonomous driving by predicting driving of surrounding vehicles based on a relationship between surrounding vehicles is provided. The vehicle includes a sensing device that obtains position information of a first vehicle and a second vehicle and a driver. A controller determines a mutual positional relationship between the second vehicle and the first vehicle based on the position information and determines an expected driving path of the first vehicle based on a relative speed of the first vehicle and the second vehicle and the mutual positional relationship. The driver is operated to maintain a collision avoidance or a safe distance from the first vehicle based on the expected driving path.

### CROSS-REFERENCE TO RELATED APPLICATION(S)

This application is based on and claims priority under 35 U.S.C. § 119 to Korean Patent Application No. 10-2019-0177851, filed on Dec. 30, 2019, the disclosure of which is incorporated by reference in its entirety.

### TECHNICAL FIELD

The disclosure relates to a vehicle providing autonomous driving, and a method of controlling the vehicle.

### BACKGROUND

An autonomous driving technology of a vehicle is a technology in which the vehicle determines a road condition and automatically drives the vehicle even if a driver does not operation a brake, a steering wheel, or an accelerator pedal. The autonomous driving technology is a core technology for smart car implementation. For autonomous driving, the autonomous driving technology may include highway driving assist (HDA, a technology that automatically maintains a distance between vehicles), blind spot detection (BSD, a technology that detects surrounding vehicles during reversing and sounds an alarm), autonomous emergency braking (AEB, a technology that activates a braking system when the vehicle does not recognize a preceding vehicle), lane departure warning system (LDWS), lane keeping assist system (LKAS, a technology that compensates for departing the lane without turn signals), advanced smart cruise control (ASCC, a technology that maintains a constant distance between vehicles at a set speed and drives at a constant speed driving), and traffic jam assistant (TJA).

In a conventional autonomous driving technology, state information and path estimation of each of target objectives is individually determined by fusion of information through sensors, such as cameras and radars and V2X communication, and appropriate control response logic is activated accordingly. However, in this case, the vehicle recognizes individually and determines only the respective impact on an ego vehicle. Therefore, there is a limitation in dealing with an immediate situation when the vehicle is suddenly started by an interaction between the target vehicles.

### SUMMARY

An aspect of the disclosure is to provide a vehicle providing safe autonomous driving by predicting driving of surrounding vehicles based on a relationship between surrounding vehicles, and a method of controlling the vehicle. Additional aspects of the disclosure will be set forth in part in the description which follows and, in part, will be obvious from the description, or may be learned by practice of the disclosure.

In accordance with an aspect of the disclosure, a vehicle may include a sensing device configured to obtain position information of a first vehicle and a second vehicle; a driver; and a controller configured to determine a mutual positional relationship between the second vehicle and the first vehicle based on the position information, to determine an expected driving path of the first vehicle based on a relative speed of the first vehicle and the second vehicle and the mutual positional relationship, and to control the driver to maintain a collision avoidance or a safe distance from the first vehicle based on the expected driving path.

The vehicle may further include a communicator configured to perform inter-vehicle communication with the first vehicle and the second vehicle. The controller may be configured to determine the mutual positional relationship between the second vehicle and the first vehicle based on the inter-vehicle communication and the position information. In response to determining that a surrounding vehicle exceeds a predetermined value related to the driving of the vehicle, the controller may be configured to determine the corresponding surrounding vehicle as the first vehicle. In addition, in response to determining that a surrounding vehicle exceeds a predetermined value related to the driving of the first vehicle, the controller may be configured to determine the corresponding surrounding vehicle as the second vehicle.

The driver may include at least one braking device. The controller may be configured to operate the at least one braking device to avoid collision with the first vehicle based on the expected driving path. The driver may include a steering device. The controller may be configured to operate the steering device to avoid collision with the first vehicle based on the expected driving path. The sensing device may include a Ladar module and a Lidar module configured to obtain surrounding information. The controller may be configured to determine the mutual positional relationship between the second vehicle and the first vehicle based on the surrounding information.

The communicator may include a global positioning system (GPS) module configured to obtain map information. The controller may be configured to determine road information on which the vehicle is being driven based on the surrounding information and the map information, and to determine the mutual positional relationship between the second vehicle and the first vehicle based on the road information. The communicator may be configured to receive traffic information from a server. The controller may be configured to determine the mutual positional relationship between the second vehicle and the first vehicle based on the traffic information. The communicator may be configured to receive weather information from a server. The controller may be configured to determine the mutual positional relationship between the second vehicle and the first vehicle based on the weather information.

### BRIEF DESCRIPTION OF THE DRAWINGS

These and/or other aspects of the disclosure will become apparent and more readily appreciated from the following description of the exemplary embodiments, taken in conjunction with the accompanying drawings of which:

FIG. 1 is a view for describing communication of an autonomous vehicle according to an exemplary embodiment.

FIG. 2 is a vehicle control block diagram according to an exemplary embodiment.

FIGS. 3A to 3C are views for describing an operation of the disclosure step by step according to an exemplary embodiment.

FIG. 4 is a view for describing an operation of a vehicle driving at an intersection according to an exemplary embodiment.

FIG. 5 is a view for describing an operation of a vehicle driving on a highway according to an exemplary embodiment.

FIG. 6 is a view for describing an operation of a vehicle driving based on road information and weather information according to an exemplary embodiment.

FIG. 7 is a view for describing an operation of a vehicle driving based on traffic information according to an exemplary embodiment.

FIG. 8 is a flowchart according to an exemplary embodiment.

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor and is specifically programmed to execute the processes described herein. The memory is configured to store the modules and the processor is specifically configured to execute said modules to perform one or more processes which are described further below.

Furthermore, control logic of the present disclosure may be embodied as non-transitory computer readable media on a computer readable medium containing executable program instructions executed by a processor, controller/control unit or the like. Examples of the computer readable mediums include, but are not limited to, ROM, RAM, compact disc (CD)-ROMs, magnetic tapes, floppy disks, flash drives, smart cards and optical data storage devices. The computer readable recording medium can also be distributed in network coupled computer systems so that the computer readable media is stored and executed in a distributed fashion, e.g., by a telematics server or a Controller Area Network (CAN).

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

Like reference numerals refer to like elements throughout the specification. Not all elements of the embodiments of the disclosure will be described, and the description of what are commonly known in the art or what overlap each other in the embodiments will be omitted. The terms as used throughout the specification, such as “˜ part,” “˜ module,” “˜ member,” “˜ block,” etc., may be implemented in software and/or hardware, and a plurality of “˜ parts,” “˜ modules,” “˜ members,” or “˜ blocks” may be implemented in a single element, or a single “˜ part,” “˜ module,” “˜ member,” or “˜ block” may include a plurality of elements.

It will be further understood that the term “connect” and its derivatives refer both to direct and indirect connection, and the indirect connection includes a connection over a wireless communication network. The terms “include (or including)” and “comprise (or comprising)” are inclusive or open-ended and do not exclude additional, unrecited elements or method steps, unless otherwise mentioned. It will be further understood that the term “member” and its derivatives refer both to when a member is in contact with another member and when another member exists between the two members. It will be understood that, although the terms first, second, third, etc., may be used herein to describe various elements, components, regions, layers and/or sections, these elements, components, regions, layers and/or sections should not be limited by these terms. These terms are only used to distinguish one element, component, region, layer or section from another region, layer or section. Reference numerals used for method steps are merely used for convenience of explanation, but not to limit an order of the steps. Thus, unless the context clearly dictates otherwise, the written order may be practiced otherwise.

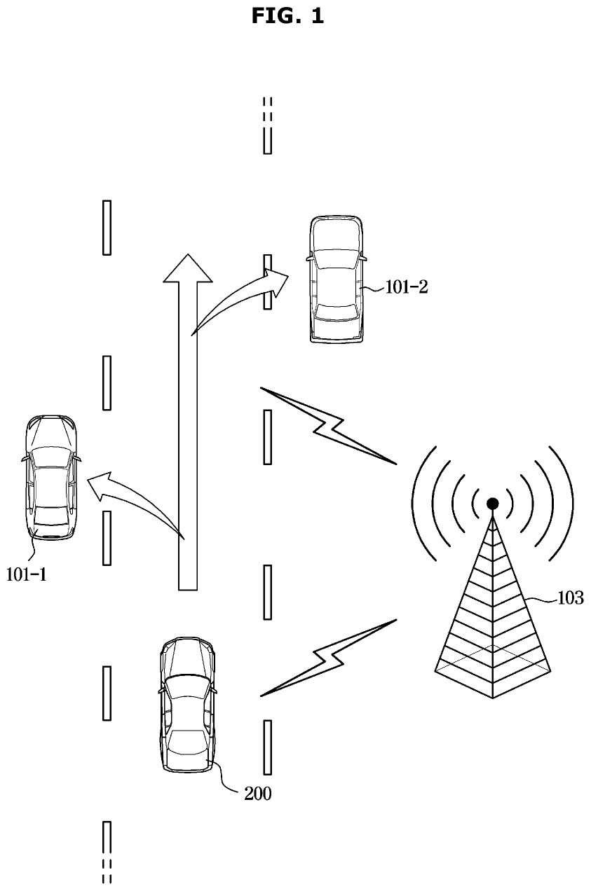

Hereinafter, an operation principle and embodiments of the disclosure will be described with reference to accompanying drawings. FIG. 1 is a view for describing communication of an autonomous vehicle according to an exemplary embodiment. Referring to FIG. 1, an operation of communicating between a first vehicle 101-1, a second vehicle 101-2, a vehicle 200, and a server 103 is illustrated.

The server 103 may exist outside the vehicle 200 and may be configured to record data transmitted from the vehicle 200. The server 103 may include a processor configured to operate and control an entire network, or connect to other networks via a mainframe or a public network, and may share hardware resources such as software resources and other equipment. Meanwhile, the first vehicle 101-1 and the second vehicle 200 may be configured to communicate with each other via a vehicle-to-vehicle (V2V) or a vehicle to everything (V2X).

The V2V may refer to vehicle-to-vehicle communication. The V2V may refer to a technology in which the vehicle 200 and the vehicle 200 exchange information with each other using network, communication, and Internet technologies themselves. The V2X may refer to a technology in which the vehicles exchange information with other vehicles, mobile devices, roads, etc. via a wired or wireless network. In other words, the first vehicle 101-1 and the second vehicle 101-2 may be configured to communicate directly with each other by the vehicle 200 via the V2V. Additionally, the first vehicle 101-1 and the second vehicle 101-2 may be configured to communicate with the V2X via the server 103.

Based on the above, the first vehicle 101-1, the second vehicle 101-2, and the vehicle 200 may be configured to transmit and receive signals between each other. Hereinafter, operations for communicating between the vehicles and operating each of the vehicles based on the operations will be described.

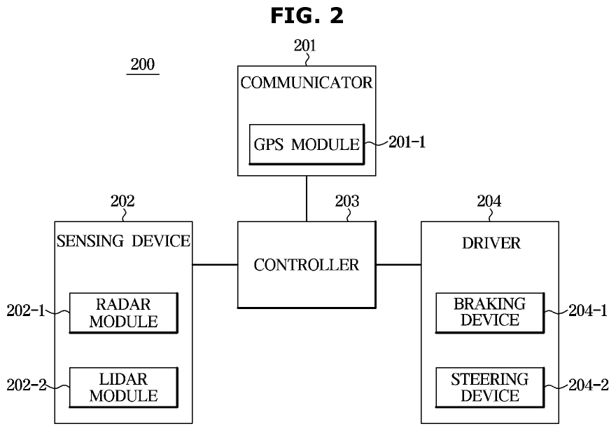

FIG. 2 is a vehicle control block diagram according to an exemplary embodiment. Referring to FIG. 2, the vehicle 200 according to an exemplary embodiment may include a communicator 201, a sensing device 202, a driver 204, and a controller 203. The communicator 201 may be configured to perform inter-vehicle communication (V2V) with surrounding vehicles. In addition, the communicator 201 may include a GPS module 201-1 that obtains map information.

The GPS module 201-1 may include a processor for diagnosing a failure by comparing sub-state variables between a track (Dead Reckoning) including a system used for precise positioning of the vehicle 200 and a vehicle internal sensor and a track of a system performing precise positioning. The communicator 201 may be configured to receive traffic information from the server 103. In addition, the communicator 201 may be configured to receive weather information from the server 103. The communicator 201 may include one or more components that enable communication with an external device, and may include, for example, at least one of a short-range communication module, a wired communication module, and a wireless communication module.

The sensing device 202 may be configured to obtain position information of surrounding vehicles. In particular, if the surrounding vehicle is a vehicle located around the vehicle 200, a position is not limited. The sensing device 202 may include a Ladar module 202-1 and a Lidar module 202-1. The Lidar module may refer to a sensor that accurately draws the surroundings by emitting a laser pulse and measuring a distance to the object by receiving a light reflected from surrounding objects. The Ladar module may refer to a sensor that detects the distance, a direction, an altitude, etc. from the object by emitting electromagnetic waves of a microwave (e.g., microwave, 10 cm to 100 cm wavelength) to the object and receiving the electromagnetic waves reflected from the object.

The driver 204 may include a configuration that controls driving of the vehicle 200. Particularly, the driver 204 may include a braking device 204-1 and a steering device 204-2. The braking device 204-1 may refer to any device that decelerates or stops a speed of the driving vehicle 200. The steering device 204-2 may be a steering mechanism including a steering wheel, a steering shaft, and the like, and may be configured to transmit a steering force of a driver to a gear device. The steering device 204-2 may be configured as a gear device that changes a direction of the steering force and simultaneously increases a rotational force and transmits the rotational force to a driving link mechanism and a link mechanism that transmits the operation of the gear device to the front wheel and correctly supports the position of left and right wheels.

The controller 203 may be configured to determine a mutual positional relationship between the second vehicle 101-2 and the first vehicle 101-1 based on the inter-vehicle communication and the position information. The first vehicle 101-1 may refer to a vehicle having a direct effect on driving of the vehicle 200. According to the exemplary embodiment, the first vehicle 101-1 may refer to a vehicle having a high risk of collision since it is located near a front of the vehicle 200. The controller 203 may be configured to determine an expected driving path of the first vehicle 101-1 based on the mutual positional relationship.

The controller 203 may be configured to determine the mutual positional relationship between the first vehicle 101-1 and the second vehicle 101-2 based on the inter-vehicle communication and the position information obtained by the sensing device 202. The mutual positional relationship between the first vehicle 101-1 and the second vehicle 101-2 may be determined by sensor fusion of a sensor provided in the vehicle 200 and vehicle-to-vehicle (V2V) or vehicle to everything (V2X).

Additionally, the controller 203 may be configured to operate the driver 204 to avoid the collision with the first vehicle 101-1 based on the expected driving path. Particularly, the controller 203 may be configured to operate the braking device 204-1 and the steering device 204-2 to avoid the collision. The controller 203 may be configured to determine the surrounding vehicle as the first vehicle 101-1 when the surrounding vehicle exceeds a predetermined value related to driving of the vehicle 200.

The controller 203 may be configured to determine whether the surrounding vehicle is related to the driving of the vehicle 200. Particularly, based on the distance between the vehicle 200 and the surrounding vehicle, a relative speed, etc., it may be possible to determine a relevance that the surrounding vehicle affects the driving of the vehicle 200. For example, if the distance between the vehicle 200 and the surrounding vehicle is less than the predetermined value, the controller 301 may be configured to determine that the relevance with the driving of the vehicle 200 exceeds the predetermined value.

The controller 203 may be configured to determine the surrounding vehicle as the second vehicle 101-2 when the surrounding vehicle exceeds the predetermined value related to the driving of the first vehicle 101-1. Particularly, the controller 203 may be configured to determine that the second vehicle 101-2 is related to the driving of the first vehicle 101-1 based on the distance between the first vehicle 101-1 and the second vehicle 101-2, the relative speed, and the like. The controller 203 may be configured to operate the at least one braking device 204-1 to avoid the collision with the first vehicle 101-1 based on the expected driving path.

Further, the controller 203 may be configured to operate the steering device 204-2 to avoid the collision with the first vehicle 101-1 based on the expected driving path. The controller 203 may be configured to determine the mutual positional relationship between the second vehicle 101-2 and the first vehicle 101-1 based on the surrounding information obtained by the sensing device 202. The surrounding information may refer to situation information around the vehicle 200 obtained by the Ladar module or the Lidar module. The surrounding information may refer to information including the objects other than the vehicle 200 and a driving environment, as well as the surrounding vehicles the driving around the vehicle 200.

The communicator 201 may include a GPS module that obtains map information. The controller 203 may be configured to determine road information on which the vehicle is being driven based on the surrounding information obtained by the sensing device 202 and the map information. The controller 203 may be configured to determine the mutual positional relationship between the second vehicle 101-2 and the first vehicle 101-1 based on the road information. The road information may include a construction section of the road on which the vehicle 200 is being driven and a weather condition of the road on which the vehicle 200 is being driven.

The communicator 201 may be configured to receive the traffic information from the server 103. The traffic information may include road condition information and may include traffic signal information. The traffic information may include all information including traffic conditions of the road on which the vehicle 200 is being driven. The controller 203 may be configured to determine the mutual positional relationship between the second vehicle 101-2 and the first vehicle 101-1 based on the traffic information. For example, the controller 203 may be configured to predict braking of the surrounding vehicle based on a traffic signal of the road on which the vehicle 200 is driving, and determine a position relationship between the surrounding vehicle and the vehicle 200 based on this.

In addition, the communicator 201 may be configured to receive the weather information from the server 103. The controller 203 may be configured to determine the mutual positional relationship between the second vehicle 101-2 and the first vehicle 101-1 based on the weather information. Particularly, since a braking distance and a speed limit of the surrounding vehicle may vary according to a weather, the controller 203 may be configured to determine the mutual positional relationship between the vehicle 200 and the surrounding vehicle based on the weather information received by the communicator 201.

The controller 203 may be implemented with a memory storing an algorithm to control operation of the components in the vehicle 200 or data about a program that implements the algorithm, and a processor configured to perform the aforementioned operation using the data stored in the memory. The memory and the processor may be implemented in separate chips. Alternatively, the memory and the processor may be implemented in a single chip. At least one component may be added or deleted corresponding to the performance of the components of the vehicle 200 illustrated in FIG. 2. It will be readily understood by those skilled in the art that the mutual position of the components may be changed corresponding to the performance or structure of the vehicle 1. In the meantime, each of the components illustrated in FIG. 2 may be referred to as a hardware component such as software and/or a field programmable gate array (FPGA) and an application specific integrated circuit (ASIC).

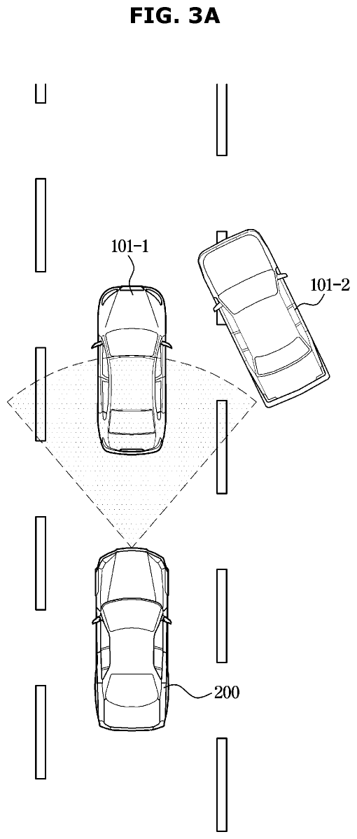

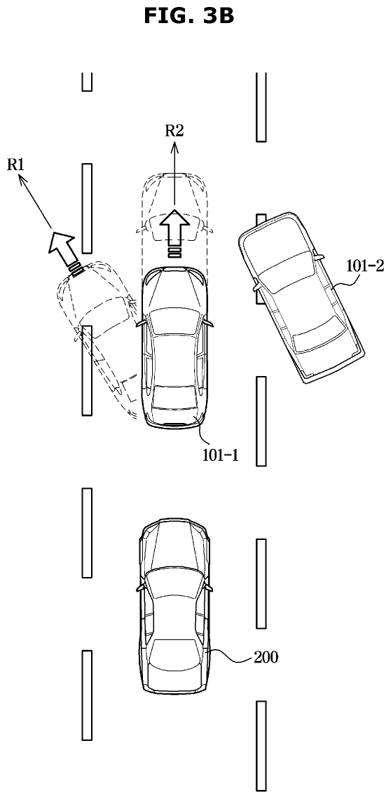

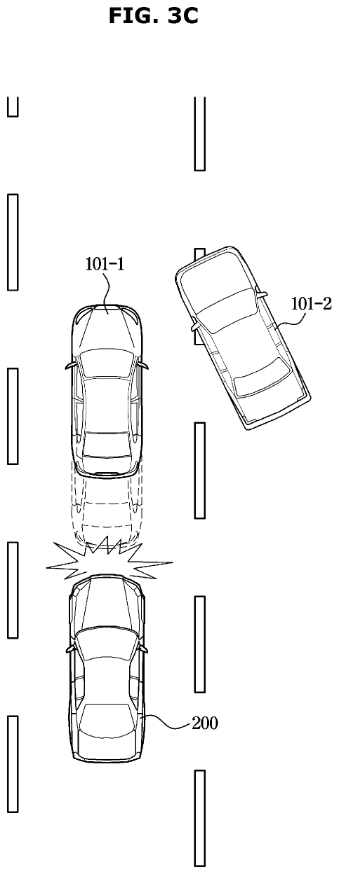

FIGS. 3A to 3C are views for describing an operation of the disclosure step by step. FIG. 3A is a view for describing an operation of determining the first vehicle 101-1 and the second vehicle 101-2 among surrounding vehicles. The vehicle 200 may be configured to determine the expected driving path of the surrounding vehicle based on communication between the sensor fusion based on the sensing device 202 provided in the surrounding vehicle and other vehicles.

Among the surrounding vehicles, a vehicle that directly affects the driving of the vehicle 200 may be referred to as the second vehicle 101-2 that directly affects the driving of the first vehicle 101-1. On the other hand, as described above, the first vehicle 101-1 may be determined based on the relationship with the driving of the vehicle 200. In addition, the second vehicle 101-2 drives in a driving direction of the first vehicle 101-1 and the relevance to the driving of the first vehicle 101-1 exceeds the predetermined value.

In FIG. 3A, the first vehicle 101-1 may be determined as the first vehicle 101-1 because the first vehicle 101-1 is located in the position close to the front of the vehicle 200 and in the driving direction of the vehicle 200. FIG. 3B illustrates an operation in which the controller 203 determines the expected driving path. As described above, the controller 203 may be configured to determine the second vehicle 101-2 that can directly affect a behavior of the first vehicle 101-1. The controller 203 may analyze driving of the first vehicle 101-1 and the second vehicle 101-2.

Particularly, the mutual positional relationship between the first vehicle 101-1 and the second vehicle 101-2 may be determined. In FIG. 3B, the controller 203 may be configured to predict the path of the first vehicle 101-1. However, the controller 203 may use the path of the second vehicle 101-2 when predicting the path of the first vehicle 101-1. Particularly, in FIG. 3B, the controller 203 may be configured to obtain position information R1 and R2 in which the second vehicle 101-2 drives in front of the first vehicle 101-1. The controller 203 may be configured to determine the mutual positional relationship that the first vehicle 101-1 and the second vehicle 101-2 approach.

On the other hand, when the second vehicle 101-2 enters the front of the first vehicle 101-1, as illustrated in FIG. 3B, the controller 203 may be configured to determine the mutual positional relationship that the first vehicle 101-1 and the second vehicle 101-2 approach, and predict that the first vehicle 101-1 decelerates or changes steering based on the mutual positional relationship. In other words, in predicting the direction of the first vehicle 101-1 located in the front, the controller 203 may be configured to predict a driving path of the first vehicle 101-1 by considering the driving of the second vehicle 101-2 instead of the first vehicle 101-1 itself.

Referring to FIG. 3C, the vehicle 200 is a view for describing an operation in which the vehicle 200 avoids the collision of the first vehicle 101-1 based on the predicted path of the surrounding vehicle predicted in FIGS. 3A and 3B. Referring to FIGS. 3B and 3C, when the first vehicle 101-1 changes the steering and moves to another lane (R1), the vehicle 200 has a low risk of collision with the first vehicle 101-1 and may continue the driving in a current state. However, when the first vehicle 101-1 is decelerated to avoid the collision with the second vehicle 101-2 (R2), if the vehicle 200 continues to drive in the current state, there is a possibility that the vehicle 200 collides with the first vehicle 101-1, and thus the controller 203 may be configured to operate the braking device 204-1 of the vehicle 200 to decelerate the vehicle 200.

As described above, the controller 203 of the vehicle 200 may be configured to determine or detect the first vehicle 101-1 and the second vehicle 101-2 among the surrounding vehicles. The controller 203 may be configured to predict the driving (e.g., driving state) of the vehicle 101-1 based on the driving of the second vehicle 101-2 to operate the driver 204 of the vehicle 200 to avoid the collision between the vehicle 200 and the first vehicle 101-1. Meanwhile, FIGS. 3A, 3B, and 3C are only one exemplary embodiment for describing the operation of the disclosure, there is no limitation in the operation of the vehicle 200 to avoid the collision in consideration of both the driving of the first vehicle 101-1 and the second vehicle 101-2.

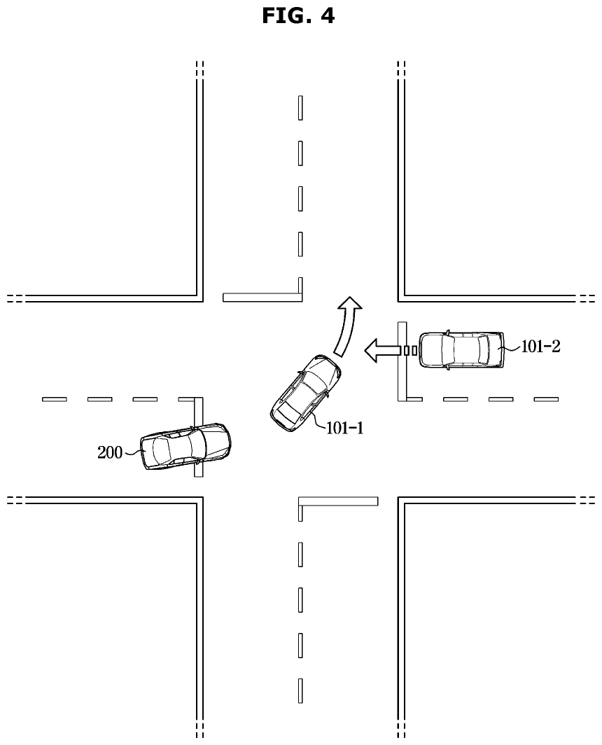

FIG. 4 is a view for describing an operation of a vehicle driving at an intersection according to an exemplary embodiment. Referring to FIG. 4, it illustrates an operation in which the vehicle 200 turns left along the first vehicle 101-1. The vehicle 200 may stop in advance by predicting the risk of collision the second vehicle 101-2 and the first vehicle 101-1 going straight ahead. In other words, the controller 203 may be configured to obtain the information of the second vehicle 101-2 approaching the first vehicle 101-1 at an intersection using the sensing device 202 or the communicator 201, and may be configured to perform a braking control to avoid the collision with the first vehicle 101-1 based on this. That is, the controller 203 may be configured to perform an operation to mitigate the risk of collision due to a rapid deceleration of the first vehicle 101-1.

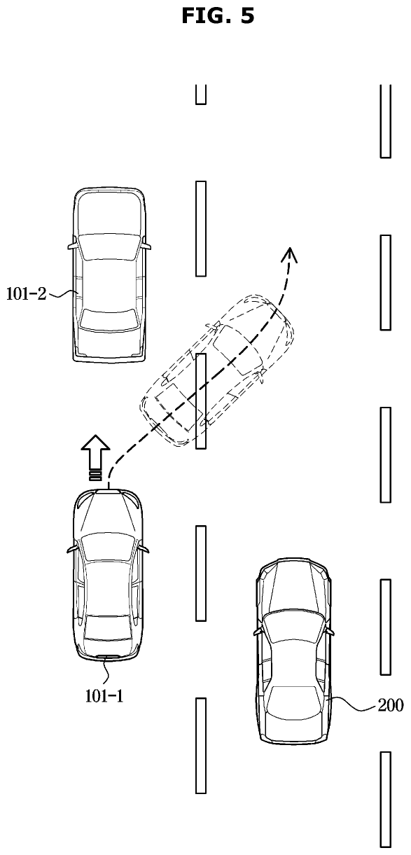

FIG. 5 is a view for describing an operation of a vehicle driving on a highway according to an exemplary embodiment. Referring to FIG. 5, FIG. 5 illustrates an operation of the vehicle 200 driving on a highway. The first vehicle 101-1 is accelerating in a lane next to the vehicle 200. Additionally, the second vehicle 101-2 is driving in front of the first vehicle 101-1.

The controller 203 may be configured to determine the possibility that the first vehicle 101-1 is driving in front of the vehicle 200 when the second vehicle 101-2 is relatively slow. In particular, the controller 203 may be configured to determine that the first vehicle 101-1 will drive in front of the vehicle 200 based on the slowing down of the second vehicle 101-2. At this time, the controller 203 may secure a safety distance in advance when the first vehicle 101-1 is driving in front of the vehicle 200. In other words, the controller 203 may use behavior information of the second vehicle 101-2 as well as the driving of the first vehicle 101-1 to predict more precisely an expected behavior of the first vehicle 101-1 due to the driving of the second vehicle 101-2. An interruption determination of the first vehicle 101-1 may be performed more rapidly than a conventional interruption determination.

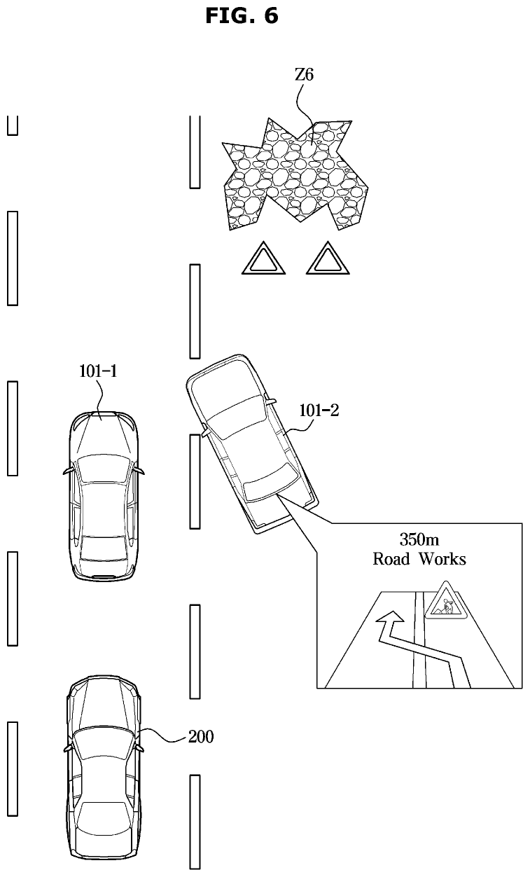

FIG. 6 is a view for describing an operation of a vehicle driving based on road information and weather information according to an exemplary embodiment. Referring to FIG. 6, it illustrates that a construction section is present on the road on which the vehicle 200 drives. In other words, the controller 203 may be configured to determine that a construction section Z6 is present on the road on which the vehicle 200 is being driven based on the road information obtained by the communicator 201 via the server 103 and the surrounding information obtained by the sensing device 202.

On the other hand, the controller 203 may be configured to recognize in advance that the second vehicle 101-2 is inevitable to change a driving lane based on this. The controller 203 may be configured to analyze a drivable path of the first vehicle 101-1 based on this. In particular, the controller 203 of the vehicle 200 may be configured to analyze the mutual positional relationship between the first vehicle 101-1 and the second vehicle 101-2, and may be configured to operate the braking device to avoid the collision with the first vehicle 101-1 to perform deceleration.

Meanwhile, as a separate exemplary embodiment, the communicator 201 may be configured to receive the weather information from the server 103. For example, the vehicle 200 that is not visible in the driving path due to fog or the like may suddenly brake. The controller 203 may be configured to perform V2X communication with the first vehicle 101-1 that is suddenly braking based on the signal obtained by the communicator 201. The controller 203 may be configured to analyze the mutual positional relationship with the second vehicle 101-2 after analyzing the drivable path of the first vehicle 101-1. The controller 203 may be configured to decelerate the vehicle 200 by operating the braking device 204-1 in response to detecting the risk of collision of the first vehicle 101-1 by the above-described operation, or may be configured to change the lane by operating the steering device 204-2 of the vehicle 200.

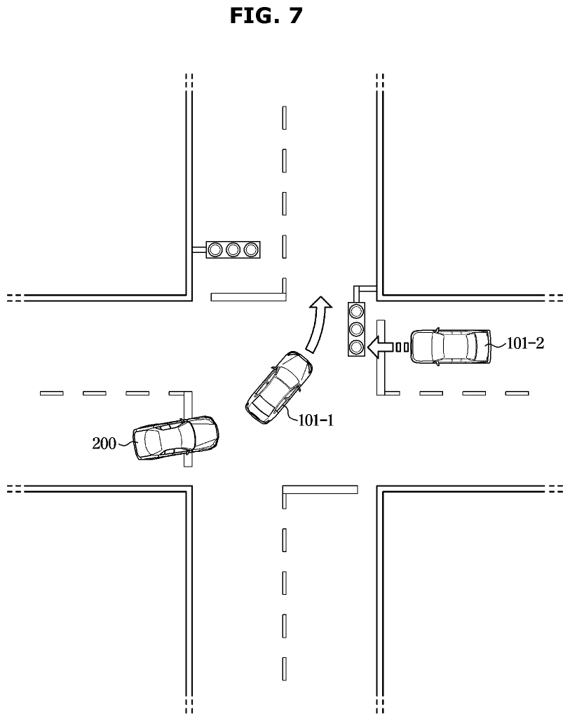

FIG. 7 is a view for describing an operation of a vehicle driving based on traffic information according to an exemplary embodiment. Referring to FIG. 7, it illustrates that the second vehicle 101-2 continues to be driven despite a stop signal. The communicator 201 may be configured to receive the traffic information including the traffic signal of the intersection from the server 103.

The controller 203 may be configured to output an indication that the second vehicle 101-2 was driven in violation of the traffic signal through confirmation of the traffic signal of the intersection and V2X communication and sensing device 202. The controller 203 may be configured to obtain a vehicle speed and driving direction information of the second vehicle 101-2. The controller 203 may be configured to predict the driving path of the first vehicle 101-1 based on the vehicle speed and the driving direction of the second vehicle 101-2. The controller 203 may be configured to analyze the risk of collision of the first vehicle 101-1 and the second vehicle 101-2. The controller 203 may be configured to determine the risk of collision between the vehicle 200 and the first vehicle 101-1 based on this. The controller 203 may be configured to decelerate and operate the vehicle 200 by operate the braking device 204-1 to avoid the collision with the first vehicle 101-1.

Meanwhile, in addition to the traffic signal, when there is a pedestrian on the road on which the vehicle 200 is being driven, the vehicle 200 may be configured to identify the pedestrian location based on the surrounding information obtained by the sensing device 202. The vehicle 200 may be configured to predict the driving paths of the first vehicle 101-1 and the second vehicle 101-2, and may be configured to predict whether there is a possibility of collision between the first vehicle 101-1 and the second vehicle 101-2 and the pedestrian based on this.

In addition, the vehicle 200 may be configured to change the direction of the vehicle 200 by decelerating the speed of the vehicle 200 or controlling the steering device 204-2 when detecting the risk of collision with the first vehicle 101-1. Meanwhile, FIGS. 4 to 7 each illustrate an exemplary embodiment of the disclosure. The operation in which vehicle 200 avoids the collision between the vehicle 200 and the first vehicle 101-1 is not limited based on the mutual positional relationship of the first vehicle 101-1 and the second vehicle 101-2.

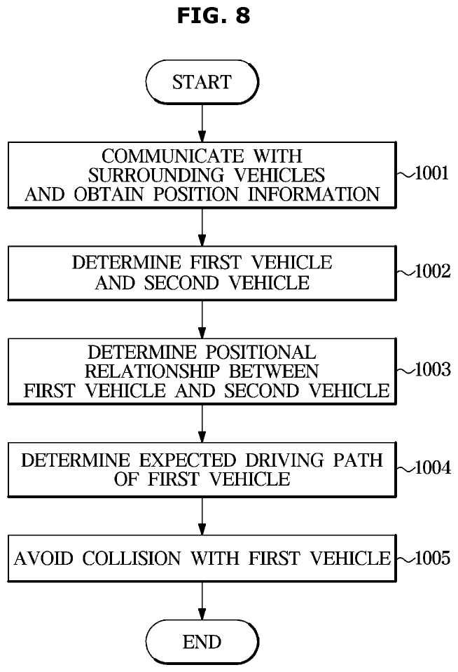

FIG. 8 is a flowchart according to an exemplary embodiment. Referring to FIG. 8, when the vehicle 200 is being driven, the vehicle 200 may be configured to communicate with the surrounding vehicles, and the vehicle 200 may be configured to obtain information about the surrounding vehicles based on the information obtained by the sensing device 202 (1001). The controller 203 may be configured to determine the vehicle that directly affects the driving of the vehicle 200 as the first vehicle 101-1, and the vehicle that affects the driving of the first vehicle 101-1 as the second vehicle 101-2 (1002).

Meanwhile, the controller 203 of the vehicle 200 may be configured to determine the positional relationship between the first vehicle 101-1 and the second vehicle 101-2 (1003). The controller 203 of the vehicle 200 may be configured to determine the driving path of the first vehicle 101-1 based on this (1004), and may be configured to operate the steering device 204-2 and the braking device 204-1 to avoid collision with the first vehicle 101-1 (1005).

According to the exemplary embodiments of the disclosure, the vehicle and the method of controlling the vehicle may provide the safe autonomous driving by predicting the driving of the surrounding vehicles in consideration of the relationship between the surrounding vehicles.

The disclosed exemplary embodiments may be implemented in the form of a recording medium storing computer-executable instructions that are executable by a processor. The instructions may be stored in the form of a program code, and when executed by a processor, the instructions may generate a program module to perform operations of the disclosed exemplary embodiments. The recording medium may be implemented non-transitory as a computer-readable recording medium. The non-transitory computer-readable recording medium may include all types of recording media storing commands that may be interpreted by a computer. For example, the non-transitory computer-readable recording medium may be, for example, ROM, RAM, a magnetic tape, a magnetic disc, flash memory, an optical data storage device, etc.

Embodiments of the disclosure have thus far been described with reference to the accompanying drawings. It should be obvious to a person of ordinary skill in the art that the disclosure may be practiced in other forms than the exemplary embodiments as described above without changing the technical idea or essential features of the disclosure. The above exemplary embodiments are only by way of example, and should not be interpreted in a limited sense.

What is claimed is:

1. A vehicle, comprising:
a sensing device configured to obtain position information of a first vehicle and a second vehicle;
a driver; and
a controller configured to
determine a mutual positional relationship between the second vehicle and the first vehicle based on the position information,
determine an expected driving path of the first vehicle based on a relative speed of the first vehicle and the second vehicle and the mutual positional relationship, and
operate the driver to maintain a collision avoidance or a safe distance from the first vehicle based on the expected driving path.

2. The vehicle according to claim 1, further comprising:
a communicator configured to perform inter-vehicle communication with the first vehicle and the second vehicle,
wherein the controller is configured to determine the mutual positional relationship between the second vehicle and the first vehicle based on the inter-vehicle communication and the position information.

3. The vehicle according to claim 1, wherein, in response to determining that a surrounding vehicle exceeds a predetermined value related to the driving of the vehicle, the controller is configured to determine the corresponding surrounding vehicle as the first vehicle.

4. The vehicle according to claim 1, wherein, in response to determining that a surrounding vehicle exceeds a predetermined value related to the driving of the first vehicle, the controller is configured to determine the corresponding surrounding vehicle as the second vehicle.

5. The vehicle according to claim 1, wherein the driver includes at least one braking device, and wherein the controller is configured to operate the at least one braking device to avoid collision with the first vehicle based on the expected driving path.

6. The vehicle according to claim 1, wherein the driver includes a steering device, and wherein the controller is configured to operate the steering device to avoid collision with the first vehicle based on the expected driving path.

7. The vehicle according to claim 1, wherein the sensing device includes a Ladar module and a Lidar module configured to obtain surrounding information, and wherein the controller is configured to determine the mutual positional relationship between the second vehicle and the first vehicle based on the surrounding information.

8. The vehicle according to claim 6, wherein the communicator includes a global positioning system (GPS) module configured to obtain map information, and wherein the controller is configured to determine road information on which the vehicle is being driven based on the surrounding information and the map information, and determine the mutual positional relationship between the second vehicle and the first vehicle based on the road information.

9. The vehicle according to claim 1, wherein the communicator is configured to receive traffic information from a server, and wherein the controller is configured to determine the mutual positional relationship between the second vehicle and the first vehicle based on the traffic information.

10. The vehicle according to claim 1, wherein the communicator is configured to receive weather information from a server, and wherein the controller is configured to determine the mutual positional relationship between the second vehicle and the first vehicle based on the weather information.
